(19) United States
(12) Patent Application Publication
(10) Pub. No.: US 2026/0359228 A1
(43) Pub. Date: Nov. 12, 2026

(54) EFFICIENT ACCESS AND UTILIZATION OF AN RDMA-ABLE CACHE FOR SNAPSHOT OPTIMIZED DISTRIBUTED DATA STORE

(71) Applicant: Oracle International Corporation, Redwood Shores, CA (US)

(72) Inventors: Siddharth Choudhary, Belmont, CA (US); Zuoyu Tao, Belmont, CA (US); Jia Shi, Campbell, CA (US); Ankur Kemkar, San Jose, CA (US); Boris Erlikhman, Mountain View, CA (US); Semen Ustimenko, Sunnyvale, CA (US)

(21) Appl. No.: 19/298,863

(22) Filed: Aug. 13, 2025

Related U.S. Application Data
(60) Provisional application No. 63/801,663, filed on May 7, 2025.

(51) Int. Cl. G06F 12/12; G06F 15/173; G06F 16/11

(52) U.S. Cl. CPC G06F 12/12; G06F 15/17331; G06F 16/128; G06F 2212/45

(57) ABSTRACT

Mechanisms are provided for implementing a snapshot optimized remote direct memory access (RDMA)-able cache. The mechanisms, for each cache line in the RDMA-able cache, key the cache line to both a snapshot Identifier and a Branch Identifier, where the Branch Identifier specifies a branch of a snapshot/clone tree data structure of snapshots or clones of a file corresponding to the cache line. The mechanisms process an input/output (IO) operation via a RDMA-able component of the RDMA-able cache memory based on the Branch Identifier to determine if there is a cache hit. The mechanisms, in response to the processing of the IO operation via the RDMA-able component resulting in a cache miss, process the IO operation via a non-RDMA-able component of the RDMA-able cache memory based on the snapshot Identifier to thereby complete the IO operation via the non-RDMA-able component.

### BENEFIT CLAIM

This application claims the benefit under 35 U.S.C. § 119(e) of provisional application 63/801,663, filed May 7, 2025, by Choudhary et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### INCORPORATION BY REFERENCE

The present application incorporates by reference, in its entirety, commonly owned and co-pending U.S. patent application Ser. No. 18/885,231 (Attorney Docket No. 50277-6426), entitled “Database Aware, Space Efficient, High Performance, Snapshots on Hyper-Scale Distributed Storage”, filed on Sep. 13, 2024; U.S. patent application Ser. No. 19/078,108 (Attorney Docket No. 50277-6546), entitled “Distributed Data Store for Efficient Snapshot Management Using Collocated Metadata”, filed on Mar. 12, 2025, and commonly owned U.S. Pat. No. 10,956,335, entitled “Non-Volatile Cache Access Using RDMA”, filed Sep. 29, 2017 and issued Mar. 23, 2021.

### FIELD OF THE INVENTION

The present invention relates to improvements in the operation of a data cache, and more specifically to improving cache operation for snapshots or clones in an Remote Data Memory Access (RDMA) able cache memory.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A snapshot-optimized data store is a data storage system that utilizes snapshots to create point-in-time copies of data. This enables fast data recovery and other functionalities, such as data mining and testing new capabilities of applications without affecting the live data. The snapshots may be created using various different technologies, such as redirect-on-write, copy-on-write, and the like, which capture changes and store only the modified data. This minimizes storage space and time required for the creation of the snapshots. Snapshots, when created, are associated with a snapshot Identifier (id) which is a unique identifier designating a specific point-in-time copy of data. The Snapshot ID is a reference for retrieval and restoring data to a particular state.

A distributed data store is a system where data is stored across multiple interconnected nodes, e.g., servers, rather than being centralized on a single node or server. This architecture offers increased storage capacity, improved fault tolerance, scalability, and other advantages.

Remote Direct Memory Access (RDMA) is a technology that enables one computer to directly access the memory of another computer without involving the Central Processing Unit (CPU) or operating system of either machine, i.e., there is a direct memory-to-memory communication. The RDMA operations may be handled by networking hardware which minimizes the involvement of the CPU and operating system. This bypasses the traditional software-based data transfer mechanism, resulting in faster and more efficient data transfer, and facilitating the creation of high-performance computing and networking environments.

In a snapshot optimized data store, efficient access and utilization of RDMA-able caches is challenging since to achieve the efficient access, input/output (IO) cannot be processed to resolve the Snapshot ID for which the allocation really happened. Moreover, to ensure optimal utilization of an RDMA-able cache, IO must be processed to identify the shared regions from parent files. This means that there are two goals which are antithesis of each other. Thus, an RDMA-able cache is not optimal for usage in a snapshot optimized distributed data store.

### BRIEF DESCRIPTION OF THE DRAWINGS

In the drawings:

FIG. 1 is an example diagram illustrating a snapshot dependency in accordance with one illustrative embodiment;

FIG. 2 is an example block diagram of an RDMA-able cache architecture in accordance with one illustrative embodiment;

FIG. 3 is an example flowchart outlining an operation for accessing the RDMA-able cache in accordance with one illustrative embodiment;

FIG. 4 is a block diagram that illustrates a computer system upon which an illustrative embodiment of the invention may be implemented; and

FIG. 5 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

For a distributed data store optimized for snapshots and clones (exact replicas or duplicates of data), efficient utilization of the cache is important. This is especially the case because, with snapshots and clones, the content of the files are identical in many cases, or having minimal differences, meaning that there may be cache entries that store duplicate data or substantially duplicated data. For example, if a system is configured to generate a cached snapshot of a file every hour, then 24 copies of the file may be generated every day, and if no writes are performed to a file, these cached snapshots will have 24 copies of the same file with no differences. Even if there is a write to the file, the writes generally do not rewrite the entirety of the files and thus, a significant amount of the file copies are the same across the snapshots. This results in an unnecessary and inefficient usage of cache resources. Thus, if the cache is not appropriately shared among the snapshots, the effective cache utilization would end up being poor due to the duplicated content. This is not desirable since cache lines are being wasted in such cases.

This problem is adequately addressed for non-RDMA-able caches by keying the cache to the actual identifier of the original snapshot Identifier (id) for which the allocation of the cache lines in the cache took place. When an input-output (IO) request arrives, and a lookup in the cache is to be performed, the IO is first resolved to identify pieces (cache lines) of the cache tagged with the original Snapshot ID for the allocation corresponding to the IO request. Then a cache lookup is performed with regard to the tagged pieces (cache lines) having the original Snapshot ID.

While this may work for non-RDMA-able caches, this solution does not work for an RDMA-able cache because the client is directly accessing the cache line after basic access validation and thus, there is no opportunity to resolve the IO into pieces (cache lines) of the cache associated with original snapshot IDs. That is, the RDMA mechanisms do not have access to the metadata specifying which snapshot IDs are associated with which cache lines in the cache and thus, a resolution of the Snapshot ID to cache lines cannot be performed when performing the direct access to the cache via the RDMA mechanisms.

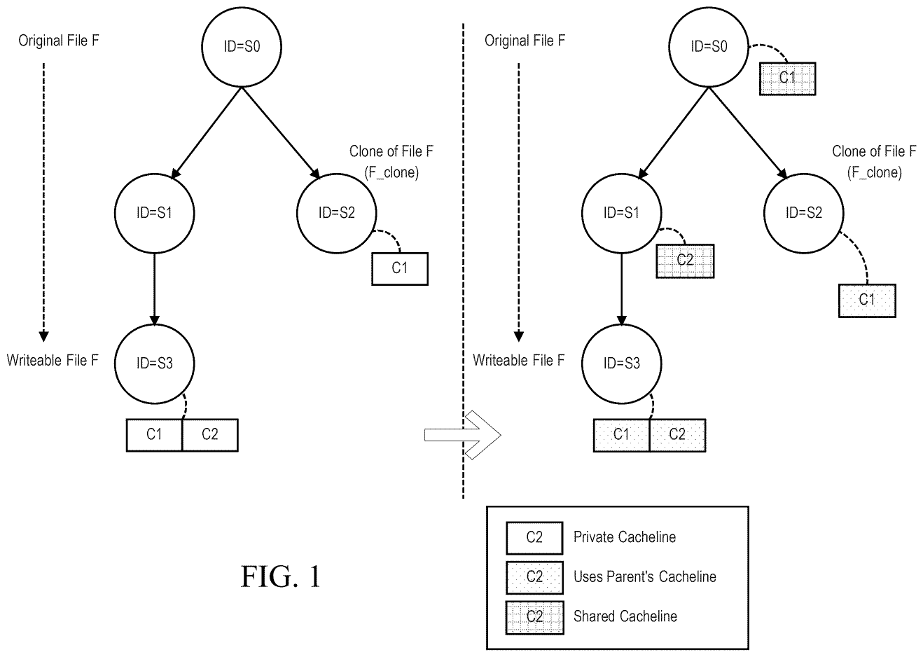

FIG. 1 is an example diagram illustrating a snapshot dependency in accordance with one illustrative embodiment. The snapshot dependency in FIG. 1 illustrates how the mechanisms of the illustrative embodiments allow multiple logical addresses to be able to reference the same cache line where data blocks for a file or volume may be stored. Moreover, FIG. 1 shows how mechanisms of the illustrative embodiments may utilize Branch IDs to facilitate RDMA-able cache operations for snapshot optimized caches using incremental snapshot storage of data in cache lines.

On the left-hand side of FIG. 1, a hierarchical representation of snapshot/clone dependencies is shown to illustrate the problems with RDMA and cached snapshots for a cache-optimized distributed data storage system. On the right-hand side of FIG. 1 is a corresponding hierarchical representation, however illustrating the desired resulting efficient RDMA-able cache access for a snapshot optimized distributed data store of the illustrative embodiments. The snapshot system in FIG. 1 is assumed to be an incremental snapshot based system, rather than a full snapshot system.

In an incremental snapshot system, the initial snapshot of a file is a full snapshot that copies all the data blocks present in the file (or volume) at that time. Thus, snapshot S0 is a full snapshot of the file (or volume), which will hereafter be considered just a file for simplicity. After the first full snapshot is generated, i.e., S0, then subsequent snapshots are incremental, meaning that they only store the data blocks that have been added or modified since the last snapshot (full or incremental). When restoring a file or volume from an incremental snapshot, the system constructs the file/volume to the point in time when the snapshot was taken by applying the changes from the incremental snapshot to the base image (either the full snapshot or a later incremental snapshot). Such incremental snapshots are more cost-efficient than full snapshots because they require less storage space and the backup process is faster. In essence, incremental snapshots act like a chain of changes where each link represents modifications since the previous one.

With reference to the left-hand side of FIG. 1, as noted above, an original version of a file is represented with the full snapshot having Snapshot ID S0, i.e., ID=S0. Thereafter, at a later time, a first incremental snapshot of the file is generated and assigned the Snapshot ID S1. The first snapshot of the file captures only those data blocks that were added or changed since the original file represented by snapshot S0. If no changes or additions were made to the file (or volume) since the state of the file (or volume) corresponding to snapshot S0, then the snapshot S1 will be empty or all zeros. If there has been a change or addition, then the snapshot S1 will store data blocks for those changed or added data blocks, while the remainer of the data blocks will be empty or zero. As most of the time writes are not performed to the entirety of a file or volume, most of the data blocks for snapshot S1 will be empty or zero, which is referred to as a sparse snapshot. As shown in FIG. 1, at yet another time, another snapshot is generated from snapshot S1, to thereby generate snapshot S3.

In addition, a clone of the file (or volume) is generated, perhaps in a different portion of the distributed storage system, and given the Snapshot ID of S2. A data clone is a complete, independent copy of data, as opposed to a snapshot which is a point-in-time, read-only or read-write copy that captures the state of data at a specific moment. Clones are fully functional, writable copies, while snapshots are typically used for recovery and testing.

With each snapshot, the snapshot captures the changes made to the previous state of the file, e.g., in the original file, previous snapshot, or previous clone, and generates, in this illustrative embodiment, a writeable version of the original file, previous snapshot, or previous clone. That is, each snapshot S0-S3 stores a copy of the changes to the file at the time the snapshot is generated. For example, the snapshot S1 captures only the changes made since the original file, i.e., snapshot S0, was stored. Similarly, the snapshot S3 captures only the changes made since snapshot S1 was stored. The changed portions are represented in the snapshots, while the remainder of the file is sparse, i.e., zero valued or empty. It should be appreciated that, in the snapshot optimized distributed storage, because the file name for the snapshotted file is changed as snapshots are generated, writing to the file is only performed at the last known visible snapshot of the file along each path, e.g., snapshot S3 or clone S2, i.e., the leaf nodes of the snapshot dependency tree, in the depicted example.

Described another way, the original file F starts as being associated with snapshot node S0. Then, when snapshot S1 is created, the parent snapshot node S0 corresponds to a “frozen-in-time” read only copy of the original file F. The original file F which originally was associated with snapshot S0 now points to snapshot S1. Thereafter, a clone of the original file F, i.e., F_clone, is created out of this read only snapshot node S0 which gives a new writeable version of the original file F, as obtained from snapshot S0, in the form of snapshot node S2 having the cloned file F_clone. It should again be noted that only leaf nodes are writable. Non leaf nodes are read only snapshot copies which correspond to the content of the file at the time when the snapshot is taken.

As shown in FIG. 1, in snapshot S3, the data for the file F in the snapshot S3 is stored in a remote distributed cache data store (e.g., an Oracle Cell server of an Oracle Exadata Database Machine) in two cache lines C1 and C2 (corresponding to snapshots) of that cache. Similarly, in clone S2, the data of the clone of File F, i.e., F_clone, is in cache line C1. These are two separate copies of the data for the file F, and if no writes occur to these copies of the data for file F, then F and F_clone are identical copies. Thus, the copies of the file F present in each snapshot S2 and S3 would result in the data of the cache line C1 being replicated in the snapshots, as each snapshot is associated with a different logical offset, and double the resources are utilized to store the snapshots/clones S2 and S3. It should be appreciated that each of these snapshots have their own snapshot IDs corresponding to different logical offsets into the cache, i.e., there is a 1-to-1 mapping of logical offset to cache lines in then remote distributed cache storage.

While this arrangement may operate properly for non-RDMA configurations, as one can perform a lookup of the cache lines based on Snapshot ID to identify all locations in all snapshots where data corresponding to a file may reside, this does not work for RDMA configurations, as there is no ability to perform a lookup based on the Snapshot ID to identify that snapshot S3 or clone S2 have data for the files F or F_clone in cache line C1 due to the direct memory access nature of RDMA operations. That is, if the data in a leaf node, which again only stores the changes from a previous state (original file, previous snapshot, previous clone), is not present in that snapshot corresponding to the leaf node, it is not possible for the RDMA mechanisms to perform the Snapshot ID based lookup needed to identify where that data may be present, i.e., which snapshot has the most recent version of the data that is not present in the snapshot of the leaf node, e.g., the portions of the file that were not changed when the snapshot of the leaf node was generated. Therefore, there is a need for a new solution that can provide efficient utilization of RDMA-able caches, allowing sharing between snapshotted files while still preserving the directly accessible nature of the RDMA-able cache.

The illustrative embodiments provide improved computing tools and improved computing tool operations/functionality that are specifically directed to solving this problem with RDMA-able caches for snapshot optimized data stores. The illustrative embodiments achieve this by providing a new Snapshot ID based tree data structure, RDMA-able cache architecture comprising a RDMA-able cache component and non-RDMA-able cache component, as well as logic that implements a snapshot optimized data storage in a RDMA-able cache based on the Snapshot ID based tree data structure and a new Branch Identifier for controlling accesses to the RDMA-able cache.

As shown in the right-hand side of FIG. 1, the improved operation of the illustrative embodiments provides, for at least the leaf nodes of the Snapshot ID based tree data structure, or for all the nodes of the Snapshot ID based tree data structure, a corresponding Branch Identifier (Branch ID) that specifies which branch of the Snapshot ID based tree data structure the node belongs to. That is, as snapshots or clones are generated, they create branches from their parent nodes in the hierarchy of the Snapshot ID based tree data structure. These branches are enumerated as they are created such that each branch has a unique identifier from the other branches. Thus, the first branch generated would have a Branch ID=1, the second branch, whether due to a clone or next snapshot, will have Branch ID=2, etc. This incrementing of the Branch ID will continue with each forked branch. Thus, for example, if a separate branch is created from node S1 for example, e.g., a node S4 is generated that branches off from node S1, then a separate Branch ID is generated for this branch, e.g., Branch ID=3.

The Branch ID can be used by the RDMA-able cache component to perform RDMA based cache accesses. For other nodes in the Snapshot ID based tree data structure, a non-RDMA-able cache component may be utilized that operates based on the Snapshot ID. This dual keying of cache lines based on Snapshot ID and Branch ID allows for sharing or reuse of cache lines from parent nodes in the Snapshot ID based tree data structure in child nodes. Thus, for example, as shown in the depiction of FIG. 1, the cache line C1, for snapshots S3 and S2, is shared from the parent node S0 and cache line C2 is shared from snapshot node S1. The unmodified data for snapshots S2 and S3 in cache lines C1 and C2 are actually stored in snapshots S0 and S1, respectively, rather than in the snapshots S2 and S3, which again only store the changed data blocks from the previous snapshots, clones, or original file.

As can be seen from the right-hand side of FIG. 1, the mechanisms of the illustrative embodiments enable multiple logical addresses to resolve to the same cache lines. That is, with the mechanisms of the illustrative embodiments, multiple snapshots are able to share the same cache line, such that multiple different logical offsets, associated with different snapshots, can be resolved to the same cache line associated with a parent snapshot where the unmodified data for the snapshot is stored. In this way, there is a many-to-one mapping of logical offsets for different snapshots to the same cache line (where the data resides) associated with a prior snapshot represented by a Snapshot ID and Branch ID. Thus, an IO operation can reference any one of these logical offsets and have it resolved to the same shared cache line in a corresponding parent snapshot.

With regard to the logical offsets, in some illustrative embodiments, the logical offset is an extent ID, i.e., a unique identifier assigned to a data shard, or extent, within a database or file system. For example, in some illustrative embodiments, the database/file system may store data using a logical space comprising 128 MB regions which are broken down into 8 MB chunks, such that the logical offset or extent ID is a 16 byte identifier which uniquely identifies the 8 MB chunk within the 128 MB region, i.e., every 8 MB chunk is an extent. A snapshot of an 8 MB chunk is a copy of the 8 MB chunk such that the Snapshot ID specifies which version of the 8 MB chunk is being referenced, and the logical offset(s) specifies a particular portion of that 8 MB chunk where the changed data blocks are located. Thus, the identifier of the chunk and the logical offset, together representing the logical address, specify a particular portion of the file that was changed or added and is present in the snapshot having a corresponding Snapshot ID. Moreover, each snapshot/clone node is given a Branch ID, e.g., B1 and B2, which specifies which branches of the Snapshot ID based tree data structure that the node belongs to, e.g., branch B1 is the left branch whereas branch B2 is the right branch in FIG. 1. The Branch ID specifies the particular branch of the Snapshot ID based tree data structure to utilize when attempting to access the unmodified data blocks corresponding to the particular snapshot, i.e., the empty or zeroed blocks of the snapshot, meaning that they were not changed from the previous snapshot, clone, or original file. As noted above, and described in greater detailed hereafter, the Branch ID can be used by the RDMA-able cache mechanisms to access the RDMA-able cache, whereas the non-RDMA-able cache mechanisms will utilize the Snapshot ID.

### Branch Identifier Based Snapshot Management

In a file's lifecycle, as snapshots and clones are created of the file, a snapshot tree data structure, such as the example shown in FIG. 1, is logically built to track and manage these snapshots and clones. This tree data structure represents the parent-child relationships that exist between all snapshots and clones of a file. Only the leaf nodes represent writeable entities and non-leaf nodes represent read-only snapshot IDs. When any logical location is materialized, such as in an allocation occurring with regard to a snapshot or clone, it is associated with whichever current node in the tree (Snapshot ID) the allocation happened on, and as more snapshots and clones are created, a tree data structure with many nodes is generated. The term “materialize” refers to a client having written to the local location, i.e., an address range in a logical address space of a file, where the first write to that logical location “materializes” the logical location. A logical location is unmaterialized if it has not yet been written to. For example, if there is a clone of an original file, initially nothing is materialized in the clone. Then, if there is a write of 1 MB on the clone, which effectively makes it different than the original parent version, the changes are considered to have “materialized” the logical location and need to be tracked. If a logical location never has any changes, it is still unmaterialized. Once a logical location is materialized, it cannot be unmaterialized, and it has overwritten the parent version's data such that visibility to the parent version is lost.

Each leaf node in the snapshot tree data structure is represented by a unique branch in the tree, which is the unique path from the leaf node all the way up to the root node of the tree data structure. In accordance with the illustrative embodiments, this branch is denoted by a Branch Identifier, or Branch ID. It should be noted that non-leaf nodes can belong to multiple branches, but a leaf node is associated with exactly one branch and thus, the Branch ID associated with the leaf node can uniquely identify the leaf node within the snapshot tree data structure.

### RDMA-Able Cache

The RDMA-able cache is broken into two components, a non-RDMA-able cache component and an RDMA-able cache component, which each key the same cache line in two different ways. The non-RDMA-able cache component keys cache lines with the Snapshot ID for which the allocation of the cache line was initially created. This ensures, just like the non-RDMA-able cache scenario described previously, that the cache is efficiently shared inside the tree data structure, i.e., shared by all the parents from the node to the root of the tree data structure. The RDMA-able cache component keys the cache lines with the Branch ID of the leaf node that resulted in the cache line being populated. Thus, each cache line is keyed with a Snapshot ID and a Branch ID. Cache population is only allowed via the non-RDMA-able path.

With this architecture, the non-RDMA-able cache component, which uses the Snapshot ID for which an allocation is materialized as the key, ensures optimal cache sharing among snapshots and clones. The RDMA-able cache component, which uses Branch Ids in which the Snapshot ID participates in as the key, ensures efficient access since clients can just look up this Branch ID using the RDMA-able cache component and find the cache line for RDMA read in case of a cache hit. Thus, the RDMA-able cache architecture of the illustrative embodiments ensures both efficient access and optimal utilization simultaneously.

When a client computing device, application, or other process (collectively referred to as the “client” herein), attempts to perform an IO operation with regard to the RDMA-able cache, the client first attempts an RDMA path by sending the request to the RDMA-able cache component of the RDMA-able cache. If the request results in a cache miss, i.e., the corresponding cache line where the data blocks are located is not found in the RDMA-able cache by the RDMA-able cache component, then the client sends the request over to the non-RDMA-able cache component via a non-RDMA path. The IO operation is performed and the decision to populate the cache may be made, such as by the cache controller which may implement the two components noted above. If it is decided to do cache population, the cache line is provided the following information:
(a) Individual fragments of the IO operation;
(b) For each individual fragment, the Snapshot ID for which the allocation originally occurred; and
(c) for the snapshot ID from (b), all Branch Ids that it is a part of.

In some implementations, the number of Branch Ids included here may be restricted for performance reasons. However, the Branch ID for the IO operation will always be included as one of these Branch Ids since the IO operation is the one that caused the population of the cache.

The non-RDMA-able cache component uses the snapshot IDs in (b) above for keying the cache line. The RDMA-able cache component uses the Branch Ids in (c) above for keying the cache line. In this way, when the next IO attempts an RDMA based cache lookup, the RDMA-able cache component returns a cache hit. Thus, with this dual keying logic and architecture, it is ensured that access efficiency and optimal utilization of the RDMA-able cache is achieved.

When a cached location is evicted, both components, i.e., the non-RDMA-able cache component and RDMA-able cache component, of the RDMA-able cache are notified and the mapping is evicted from both before the cache line can be reclaimed. In scenarios where the eviction is with regard to a large number of cache lines, such as when formatting a disk, for example, a general invalidation for everything on the disk in the RDMA-able cache component is performed and the non-RDMA-able cache component is just notified for each individual allocation. This is done to address cases where determining Branch IDs for an allocation is additional effort that will end up being wasted CPU cycles since the file tree data structure would need to be accessed many times.

Thus, the illustrative embodiments separate the RDMA-able cache into two components with each component using a different key for the cache line, e.g., the Snapshot ID and Branch ID. By using two different keys for each cache line, and having two different paths for accessing the cache lines using these different keys, multiple nodes in the snapshot (and clone) tree data structure are permitted to be accessible using the same RDMA-able key. Moreover, when there is a snapshot creation, since only the associated Snapshot ID is the one that is changing, and the Branch ID remains the same, the RDMA-able cache sees no additional cache misses due to snapshot creation.

Furthermore, when there is a cache miss in the RDMA-able cache component, there is still a possibility that it is not a true cache miss but just an RDMA-able cache component cache miss. In such a case if, after IO resolution, it is seen that the cache line is indeed present for the Snapshot ID, but just the RDMA-able cache component lacks the Branch ID entry for it, it is quickly updated and the cache memory is able to be used. This is the case for a clone creation. So even on a new clone creation, the cache is reused fully with just a minor false RDMA lookup table miss.

The illustrative embodiments provide efficient access and optimal utilization of the RDMA-able cache memory simultaneously. The illustrative embodiments achieve both with no performance impact on the RDMA-able cache with regard to snapshot or clone creation for the original file. Moreover, there is only a minimal impact (An initial RDMA-miss followed by a non-RDMA hit) when a clone is first accessed.

The illustrative embodiments implement additional memory to maintain the non-RDMA-able and RDMA-able mapping for the cache, which means for caches that are very large in size, this additional memory cost can be expensive. A solution for this is to implement additional constraints to limit the RDMA-able cache component size since that component holds information about multiple branches and thus, is comparatively the more expensive part. Another solution is to limit how many branches can be mapped for a cache line. These solutions have an advantage that even if the RDMA-able cache component has a cache miss, it is still possible to have a cache hit via the non-RDMA path which is still better than not having the cache line in the cache at all.

Unlike how snapshot creation shows no impact to the client, clone creation results in a new branch being added which needs to be updated in the cache's RDMA-able component. This means, clones always result in an RDMA miss followed by a hit via the non-RDMA path which is suboptimal. A solution to this can be proactively informing storage of a clone creation as part of the creation itself, so the associated RDMA-able cache component entries can be updated before-hand. Once the workload starts using the clone, there is no perceived impact on performance. Since not all clones are so critical that an RDMA-miss followed by non-RDMA hit is problematic, this is something which can be done for more relatively important file clones, as determined by a prioritization mechanism.

### Example Architecture of Snapshot Optimized RDMA-Able Cache

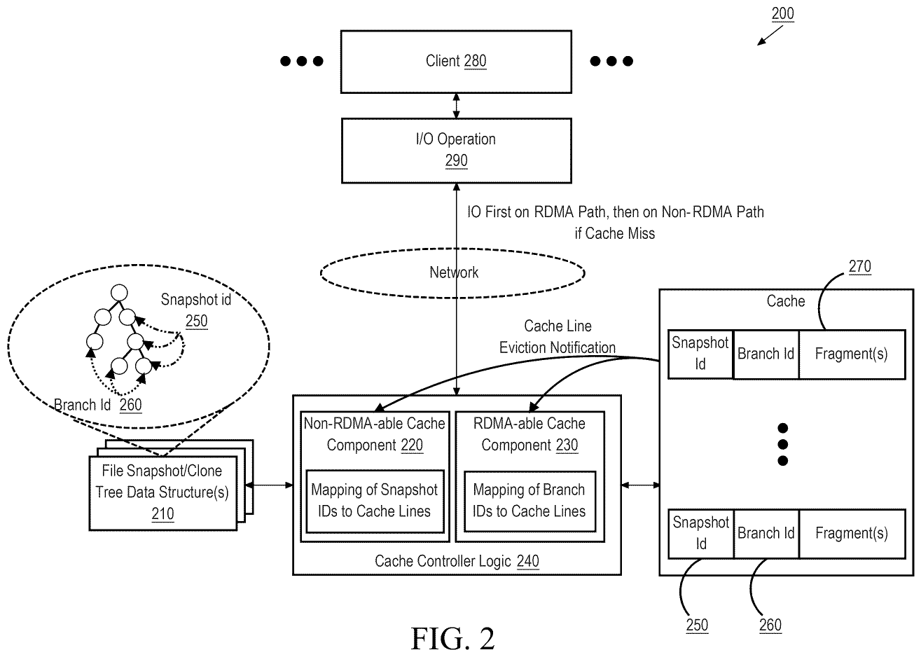

FIG. 2 is an example block diagram of an RDMA-able cache architecture in accordance with one illustrative embodiment. As shown in FIG. 2, improved computing tools and improved computing tool operations/functionality are provided that are specifically directed to solving the problems with RDMA-able caches for snapshot optimized data stores. An example architecture for these improved computing tools and functionality/operation, as shown in FIG. 2, includes a RDMA-able cache 200 that implements a snapshot/clone tree data structure 210 that is generated based on snapshot IDs which are assigned to snapshots and/or clones when they are generated, to uniquely identify those snapshots/clones. The RDMA-able cache 200 is divided into a non-RDMA-able cache component 220 and a RDMA-able cache component 230, and cache controller logic 240 that implements a snapshot optimized data storage in a RDMA-able cache 200 based on the Snapshot ID based tree data structure 210 and a new Branch ID for controlling writes to the RDMA-able cache 200.

The snapshot/clone tree data structure 210 is logically built, for each file, to track and manage the snapshots and clones associated with that file. The snapshot/clone tree data structure 210 represents the parent-child relationships that exist between all snapshots and clones of the file. However, only the leaf nodes, i.e., the most recent snapshots/clones, of this tree data structure 210 represent writeable entities. Non-leaf nodes represent read-only snapshots/clones. Each node has an associated Snapshot ID and, as described hereafter, a Branch ID. When any logical location is in this tree data structure 210 is referenced, such as in an allocation occurring with regard to a snapshot or clone, it is associated with whichever current node in the tree (Snapshot ID) the allocation happened on, and as more snapshots and clones are created, the tree data structure 210 continues to grow and expand with additional nodes.

Each leaf node in the tree data structure 210 is represented by a unique branch in the tree, which is the unique path from the leaf node all the way up to the root node of the tree data structure. This branch is denoted by a Branch Identifier, or Branch ID. It should be noted that non-leaf nodes can belong to multiple branches, but a leaf node is associated with exactly one branch and thus, the Branch ID associated with the leaf node can uniquely identify the leaf node within the tree data structure 210. The Branch ID may be used to identify snapshots/clones for RDMA operations, while the Snapshot ID is used for non-RDMA operations.

That is, the RDMA-able cache memory 200 is broken into two components, a non-RDMA-able cache component 220 and an RDMA-able cache component 230, which each key the same cache line in two different ways. The non-RDMA-able cache component 220 keys cache lines with the Snapshot ID 250 for which the allocation of the cache line 270 was initially created. This ensures that the cache is efficiently shared inside the tree data structure 210. The RDMA-able cache component 230 keys the cache lines 270 with the Branch ID 260 of the leaf node that resulted in the cache line 270 being populated. Thus, each cache line 270 is keyed with a Snapshot ID 250 and a Branch ID 260. Cache population, i.e., writing to the cache 200, is only allowed via the non-RDMA-able path.

With this architecture, the non-RDMA-able cache component 220, which uses the Snapshot ID 250 for which an allocation is materialized as the key, ensures optimal cache sharing among snapshots and clones. The RDMA-able cache component 230, which uses Branch Ids 260 in which the Snapshot ID 250 participates in as the key, ensures efficient access since clients can just look up, via this RDMA-able cache component 230, and find the cache line 270 for RDMA read in case of a cache hit. Thus, the RDMA-able cache architecture 200 of the illustrative embodiments ensures both efficient access and optimal utilization simultaneously.

When a client 280, attempts to perform an IO operation 290 with regard to the RDMA-able cache 200, the client 280 first attempts an RDMA path by sending the request to the RDMA-able cache component 230 of the RDMA-able cache 200. A cache lookup is performed by the cache controller logic 240 in the mappings for the file specified by the IO operation 290, which include mappings to Snapshot ID and, in accordance with the illustrative embodiments, a Branch ID if it is currently mapped. If the request results in a cache miss, i.e., the corresponding cache line is not found in the RDMA-able cache 200 by the RDMA-able cache component 230, then the client sends the request over to the non-RDMA-able cache component 220 via a non-RDMA path. The IO operation 290 is performed and the decision to populate the cache, such as with cache line 270, may be made, such as by the cache controller logic 240 which may implement the two components 220 and 230. If it is decided to do cache population, the cache line 270 is provided with the individual fragments of the IO operation, the Snapshot ID for each individual fragment for which the allocation originally occurred, and for the Snapshot ID, all Branch Ids that the Snapshot ID is a part of. Thus, the cache line 270 is keyed by Snapshot ID and Branch ID. In some implementations, the number of Branch Ids included here may be restricted for performance reasons. However, the Branch ID for the IO operation 290 will always be included as one of these Branch Ids of the cache line 270, since the IO operation 290 is the one that caused the population of the cache.

The non-RDMA-able cache component 220 uses the snapshot IDs for keying the cache line 270 in the mapping of files to cache lines. The RDMA-able cache component 230 uses the Branch Ids for keying the cache line 270 in mapping of files to cache lines. In this way, when the next IO attempts an RDMA based cache lookup providing the Snapshot ID and Branch ID, the RDMA-able cache component 230 returns a cache hit. Thus, with this dual keying logic and RDMA-able cache architecture 200, it is ensured that access efficiency and optimal utilization of the RDMA-able cache 200 is achieved.

When a cache line is evicted, both components 220, 230 of the RDMA-able cache 200 are notified and the mapping is evicted from both before the cache line 270 can be reclaimed. As noted previously, when the eviction targets a large number of cache lines, such as when formatting a disk, for example, a general invalidation for everything on the disk in the RDMA-able cache component 230 is performed and the non-RDMA-able cache component 220 is just notified for each individual allocation. This is done to address cases where determining Branch Ids for an allocation is additional effort that will end up being wasted CPU cycles since the file snapshot/clone tree data structure 210 would need to be accessed many times.

### Example Operation of Snapshot Optimized RDMA-Able Cache

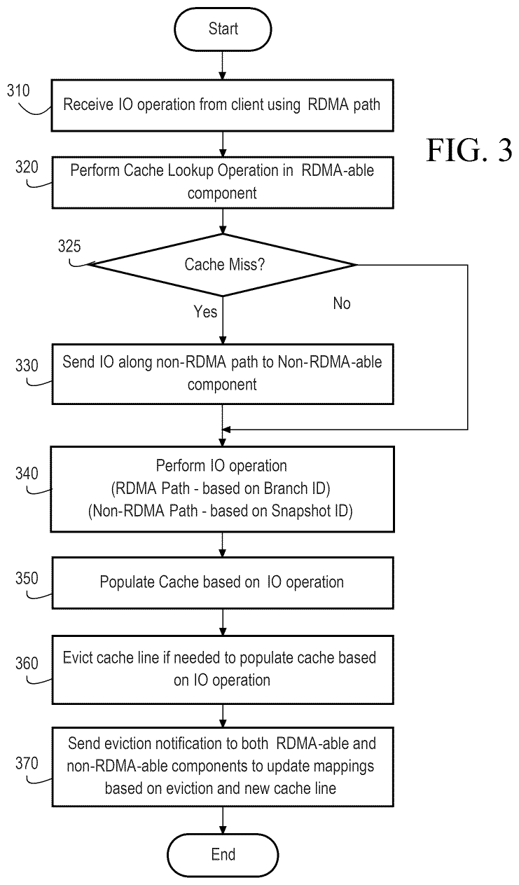

FIG. 3 is an example flowchart outlining an operation for accessing the RDMA-able cache in accordance with one illustrative embodiment. As shown in FIG. 3, the operation starts with the receipt of an IO operation from a client using the RDMA path (step 310). A cache lookup operation is performed in the RDMA-able cache component to determine if there is a cache hit (step 320). This cache lookup attempts to find a mapping for the targeted file that has a corresponding Branch ID, for example. If there is a mapping found, this results in a cache hit; otherwise a cache miss occurs. If there is a cache miss (step 325: YES), then the IO is sent along the non-RDMA path to the non-RDMA-able cache component (step 330). Either via the non-RDMA-able component, or in response to a cache hit (step 325: NO), the IO operation is performed (step 340). In the case of the non-RDMA-able component, the IO operation is performed based on the Snapshot ID, whereas in the case of the RDMA-able component and a cache hit in step 320, the IO operation is performed based on the Branch ID.

Population of the cache based on the IO operation may then be performed (step 350). The population of the cache may require an eviction of an existing cache line (step 360). If a cache line is to be evicted for performing such population, or evicted for any other reason, both the non-RDMA-able cache component and RDMA-able cache component are notified of the eviction (step 370). The components update their corresponding mappings based on the eviction and the addition of the new cache line with its Snapshot ID and Branch ID (step 380). The operation then terminates.

Thus, the improved computing tool and improved computing tool operations/functionality facilitate the implementation of a snapshot optimized RDMA cache which solves the problems of having access to snapshot IDs while performing RDMA into the RDMA cache. The RDMA-able cache of the illustrative embodiments comprises two primary components that each use a different key, i.e., a Snapshot ID and a Branch ID, respectively, for each cache line. These two different keys provide two different pathways for accessing the cache lines, such that multiple nodes in the snapshot/clone tree data structure are permitted to be accessible using the same RDMA-able key and, when there is a snapshot creation, the RDMA-able cache sees no additional cache misses due to snapshot creation, as previously noted above.

Furthermore, a cache miss in the RDMA-able cache component may not be a true cache miss but just an RDMA-able cache component cache miss. If, after IO resolution, it is seen that the cache line is present for the Snapshot ID, but just the RDMA-able cache component lacks the Branch ID entry for it, it is quickly updated and the cache memory able to be used. Thus, even on a new clone creation, the cache is reused fully with just a minor false RDMA lookup table miss.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

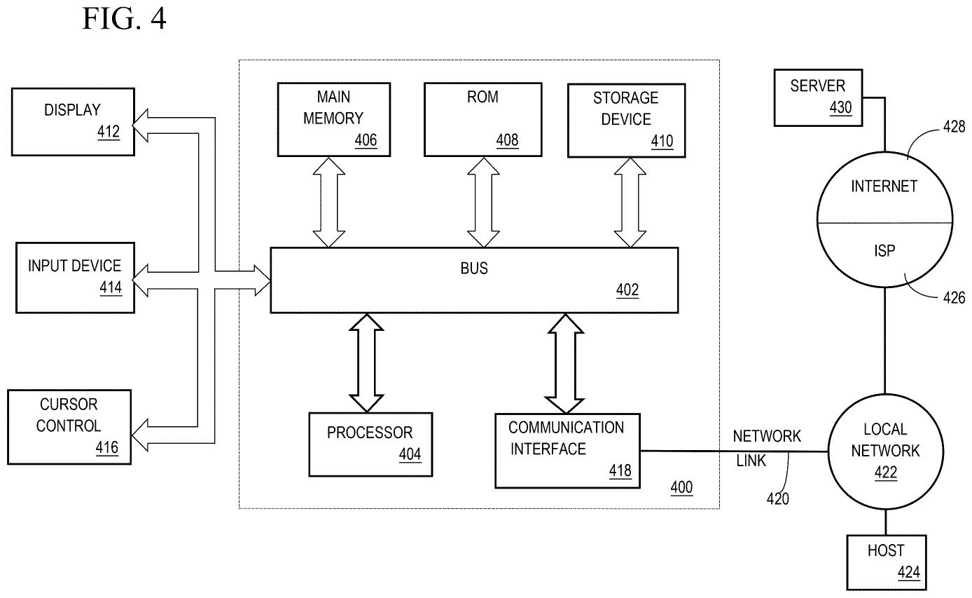

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

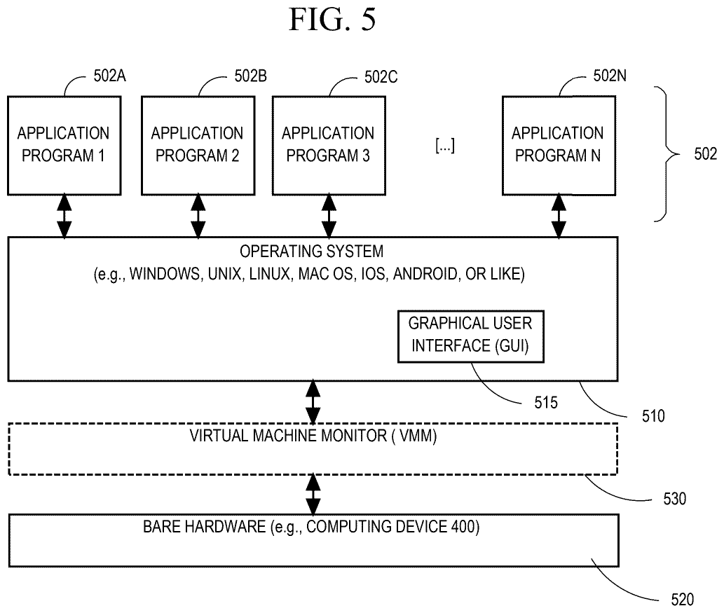

FIG. 5 is a block diagram of a basic software system 500 that may be employed for controlling the operation of computer system 400 upon which aspects of the illustrative embodiments may be implemented. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

In some illustrative embodiments, the agentic AI system, as well as the explainability tool, may be provided as part of a cloud computing service. The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

### Oracle Database

The above illustrative embodiments provide mechanisms for providing a RDMA-able cache for a snapshot optimized distributed data store. One example of such a snapshot optimized distributed data store may be a database, such as the Oracle Database, although the mechanisms of the illustrative embodiments may be used with any snapshot optimized storage system. Oracle Database (DB) is a highly scalable and flexible relational database management system (DBMS) widely used in enterprise environments. It is designed to efficiently store, retrieve, and manage large volumes of structured and unstructured data while supporting a wide range of applications and workloads. Since its inception in the late 1970s, Oracle Database has continually evolved, offering robust features that cater to enterprise-grade requirements for performance, scalability, and security.

### DBMS Overview

A database management system (DBMS) manages a database, with a relational DBMS (or RDBMS) managing a relational database, such as Oracle DB. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, a branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. . java file) and the compiled version of the class (i.e. . class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data type and to be processed by a DBMS in database statements. In general, database software of a DBMS is programmed to recognize and process native data types without configuring the DBMS to do so by, for example, defining a data type by issuing DDL statements to the DBMS.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
for each cache line in a remote direct memory access (RDMA)-able cache memory, keying the cache line to both a Snapshot Identifier and a Branch Identifier, wherein the Branch Identifier specifies a branch of a snapshot/clone tree data structure of snapshots or clones of a file corresponding to the cache line;
processing a first input/output (IO) operation, having a first Snapshot Identifier (ID) and a first Branch ID, via a RDMA-able component associated with the RDMA-able cache memory to determine whether there is a cache hit in the RDMA-able cache memory;
completing the first IO operation via the RDMA-able component in response to the first Branch ID resulting in a cache hit in the RDMA-able cache memory;
processing a second IO operation, having a second Snapshot ID and second Branch ID, via the RDMA-able component associated with the RDMA-able cache memory; and
completing the second IO operation via a non-RDMA-component associated with the RDMA-able cache memory based on the second Snapshot ID in response to a cache miss in the RDMA-able cache memory.

2. The method of claim 1, further comprising generating, for each file in one or more files, a corresponding snapshot/clone tree data structure specifying a parent-child relationship between snapshots or clones of the file, wherein each node in the snapshot/clone tree data structure is associated with a corresponding Snapshot Identifier.

3. The method of claim 2, wherein leaf nodes of the snapshot/clone tree data structure have associated Branch Identifiers (IDs).

4. The method of claim 1, further comprising:
in response to completing the second IO operation via the non-RDMA-able component, determining whether to populate the RDMA-able cache memory with a cache line corresponding to the second IO operation; and
in response to a determination to populate the RDMA-able cache memory with a cache line, updating a mapping of at least one of the RDMA-able component or the non-RDMA-able component with a Snapshot Identifier and Branch Identifier corresponding to the second IO operation.

5. The method of claim 4, wherein populating the RDMA-able cache memory with the cache line comprises evicting an existing cache line in the RDMA-able cache memory and notifying both the RDMA-able component and the non-RDMA-able component to update corresponding mappings based on the eviction.

6. The method of claim 4, wherein in response to a determination to populate the RDMA-able cache memory with a cache line, storing in the cache line the individual fragments of the second IO operation and, for each individual fragment, a Snapshot ID for which the cache line allocation originally occurred, and for each Snapshot ID, all Branch IDs that the Snapshot ID is part of.

7. The method of claim 1, wherein cache population is permitted only via the non-RDMA-able component.

8. One or more non-transitory computer-readable media storing instructions which, when executed by one or more processors, cause performance of:
for each cache line in a remote direct memory access (RDMA)-able cache memory, keying the cache line to both a Snapshot Identifier and a Branch Identifier, wherein the Branch Identifier specifies a branch of a snapshot/clone tree data structure of snapshots or clones of a file corresponding to the cache line;
processing a first input/output (IO) operation, having a first Snapshot Identifier (ID) and a first Branch ID, via a RDMA-able component associated with the RDMA-able cache memory to determine whether there is a cache hit in the RDMA-able cache memory;
completing the first IO operation via the RDMA-able component in response to the first Branch ID resulting in a cache hit in the RDMA-able cache memory;
processing a second IO operation, having a second Snapshot ID and second Branch ID, via the RDMA-able component associated with the RDMA-able cache memory; and
completing the second IO operation via a non-RDMA-component associated with the RDMA-able cache memory based on the second Snapshot ID in response to a cache miss in the RDMA-able cache memory.

9. The one or more non-transitory computer readable media of claim 8, further comprising generating, for each file in one or more files, a corresponding snapshot/clone tree data structure specifying a parent-child relationship between snapshots or clones of the file, wherein each node in the snapshot/clone tree data structure is associated with a corresponding Snapshot Identifier.

10. The one or more non-transitory computer readable media of claim 9, wherein leaf nodes of the snapshot/clone tree data structure have associated Branch Identifiers (IDs).

11. The one or more non-transitory computer readable media of claim 8, further comprising:
in response to completing the second IO operation via the non-RDMA-able component, determining whether to populate the RDMA-able cache memory with a cache line corresponding to the second IO operation; and
in response to a determination to populate the RDMA-able cache memory with a cache line, updating a mapping of at least one of the RDMA-able component or the non-RDMA-able component with a Snapshot Identifier and Branch Identifier corresponding to the second IO operation.

12. The one or more non-transitory computer readable media of claim 11, wherein populating the RDMA-able cache memory with the cache line comprises evicting an existing cache line in the RDMA-able cache memory and notifying both the RDMA-able component and the non-RDMA-able component to update corresponding mappings based on the eviction.

13. The one or more non-transitory computer readable media of claim 11, wherein in response to a determination to populate the RDMA-able cache memory with a cache line, storing in the cache line the individual fragments of the second IO operation and, for each individual fragment, a Snapshot ID for which the cache line allocation originally occurred, and for each Snapshot ID, all Branch IDs that the Snapshot ID is part of.

14. The one or more non-transitory computer readable media of claim 8, wherein cache population is permitted only via the non-RDMA-able component.

15. An apparatus, comprising:
a processor; and
a memory coupled to the processor, wherein the memory comprises instructions which, when executed by the processor, cause the processor to execute the process comprising:
for each cache line in a remote direct memory access (RDMA)-able cache memory, keying the cache line to both a Snapshot Identifier and a Branch Identifier, wherein the Branch Identifier specifies a branch of a snapshot/clone tree data structure of snapshots or clones of a file corresponding to the cache line;
processing a first input/output (IO) operation, having a first Snapshot Identifier (ID) and a first Branch ID, via a RDMA-able component associated with the RDMA-able cache memory to determine whether there is a cache hit in the RDMA-able cache memory;
completing the first IO operation via the RDMA-able component in response to the first Branch ID resulting in a cache hit in the RDMA-able cache memory;
processing a second IO operation, having a second Snapshot ID and second Branch ID, via the RDMA-able component associated with the RDMA-able cache memory; and
completing the second IO operation via a non-RDMA-component associated with the RDMA-able cache memory based on the second Snapshot ID in response to a cache miss in the RDMA-able cache memory.

16. The apparatus of claim 15, further comprising generating, for each file in one or more files, a corresponding snapshot/clone tree data structure specifying a parent-child relationship between snapshots or clones of the file, wherein each node in the snapshot/clone tree data structure is associated with a corresponding Snapshot Identifier.

17. The apparatus of claim 16, wherein leaf nodes of the snapshot/clone tree data structure have associated Branch Identifiers (IDs).

18. The apparatus of claim 15, further comprising:
in response to completing the second IO operation via the non-RDMA-able component, determining whether to populate the RDMA-able cache memory with a cache line corresponding to the second IO operation; and
in response to a determination to populate the RDMA-able cache memory with a cache line, updating a mapping of at least one of the RDMA-able component or the non-RDMA-able component with a Snapshot Identifier and Branch Identifier corresponding to the second IO operation.

19. The apparatus of claim 18, wherein populating the RDMA-able cache memory with the cache line comprises evicting an existing cache line in the RDMA-able cache memory and notifying both the RDMA-able component and the non-RDMA-able component to update corresponding mappings based on the eviction.

20. The apparatus of claim 18, wherein in response to a determination to populate the RDMA-able cache memory with a cache line, storing in the cache line the individual fragments of the IO operation and, for each individual fragment, a Snapshot ID for which the cache line allocation originally occurred, and for each Snapshot ID, all Branch IDs that the Snapshot ID is part of.
